(19) United States
(12) Patent Application Publication
(10) Pub. No.: US 2010/0219215 A1
(43) Pub. Date: Sep. 2, 2010

(54) CLOTHES HANGING DEVICE AND METHOD THEREFOR

(76) Inventor: Duane Davis, Redondo Beach, CA (US)

Correspondence Address: WEISS & MOY PC, 4204 NORTH BROWN AVENUE, SCOTTSDALE, AZ, 85251, US

(21) Appl. No.: 12/396,119

(22) Filed: Mar. 2, 2009

(51) Int. Cl. A41D 27/22; B23P 11/00

(52) U.S. Cl. 223/85; 29/428

(57) ABSTRACT

An improved clothes hanging device and method therefor capable of holding an article of clothing in place using a minimum amount of material while maintaining an effective amount of strength and rigidity.

### FIELD OF THE INVENTION

This invention relates generally to hangers and, more specifically, to an improved clothes hanging device and method therefore capable of utilizing a reduced amount of material while maintaining or improving the integral strength of the device.

### BACKGROUND OF THE INVENTION

The clothes hanger has been around in one form or another for more than a century. While there have been many changes in the shape and composition, it appears that none of the changes have been made with the intention of reducing the amount of material necessary to form the standard clothes hanger while maintaining or even improving structural integrity of the hanger.

This invention addresses this problem by providing an improved clothes hanging device being comprised of less material than the standard clothes hanger while still being able to withstand the typical load of the standard clothes hanger.

### SUMMARY OF THE INVENTION

An object of the present invention is to provide an improved clothes hanging device capable of being formed using a reduced amount of material when compared to that of a standard clothes hanger.

It is a further object of the present invention to provide an improved clothes hanging device having greater strength than, and therefore being able to support a heavier load than, a standard clothes hanger.

### BRIEF DESCRIPTION OF THE PREFERRED EMBODIMENTS

In accordance with one embodiment of the present invention, an improved clothes hanging device is disclosed, comprising, in combination, a first flange having an outer surface and an inner surface and a first end and a second end, a second flange having an outer surface and an inner surface and a first end and a second end, a first web having a top surface and a bottom surface and a first end and a second end, the inner surface of the first flange coupled to the top surface of the first web, the inner surface of the second flange coupled to the bottom surface of the first web so that the first flange and the second flange and the first web forming a first portion defining a channel between the first flange and the second flange, the first portion being formed into one of a substantially triangular shape and a substantially trapezoidal shape and a substantially inverted V-shape having a wide base and an apex, a third flange including an outer surface and an inner surface and a first end and a second end, a fourth flange including an outer surface and an inner surface and a first end and a second end, and a second web having a top surface and a bottom surface and a first end and a second end, the inner surface of third first flange coupled to the top surface of the second web, the inner surface of the fourth flange coupled to the bottom surface of the second web so that the third flange and the fourth flange and the second web forming a second portion defining a channel between the third flange and the fourth flange, the second portion being formed into a substantially hook-like shape having a distal end and a proximate end, the proximate end of the substantially hook-like shaped second portion coupled proximate the apex of one of the substantially triangularly shaped first portion and the substantially trapezoidally shaped first portion and the substantially inverted V-shaped first portion, the first portion and the second portion forming a one-piece assembly.

In accordance with another embodiment an improved clothes hanging device is disclosed, comprising, in combination, a substantially hollow cylindrically shaped tube having an inner surface and an outer surface and a first end and a second end, the substantially hollow cylindrically shaped tube forming a first portion and a second portion, the first portion being formed into one of a substantially triangular shape having an apex and a wide base and a dual arm device having an apex and a wide base and a substantially trapezoidal shape having a wide base and an apex, the second portion forming a substantially hook-like shape proximate one of the apex of the substantially triangularly shaped first portion and the apex of the substantially trapezoidally shaped first portion and the apex of the substantially inverted V-shaped first portion.

In accordance with yet another embodiment, a method for forming an improved clothes hanging device is disclosed, comprising, in combination, the steps of providing a piece of material, rolling the material into a substantially I-shaped beam, bending a first portion of the I-shaped beam into one of a substantially triangular shape and a substantially trapezoidal shape and a substantially inverted V-shape having a wide base and an apex, bending a second portion of the substantially I-shaped beam into a substantially hook-like shape having a distal end and a proximate end, and strengthening a third portion of the substantially I-shaped beam, the third portion of the substantially I-shaped beam being disposed between the proximate end of the substantially hook-like shaped second portion and the apex of the first portion, the strengthening being one of twisting and welding and heating.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is an elevated perspective view of one embodiment of the improved clothes hanging device of the present invention wherein a pair of flanges are coupled together by a web that defines a channel therebetween and forms a one-piece substantially trapezoidal shape having an apex coupled to a substantially hook-like shape;

FIG. 2 is an end cross-sectional view of the improved clothes hanging device shown in FIG. 1, taken along line 2-2;

FIG. 2a is an end cross-sectional view of the improved clothes hanging device shown in FIG. 1, taken along line 2a-2a;

FIG. 3 is a partial perspective view of the wide base of the improved clothes hanging device shown in FIG. 1;

FIG. 4 is an elevated perspective view of one embodiment of the improved clothes hanging device of the present invention, showing a substantially hollow cylindrically shaped tube that forms a one-piece substantially trapezoidal shape having an apex coupled to a substantially hook-like shape;

FIG. 5 is a partial cross-sectional view of the improved clothes hanging device shown in FIG. 4;

FIG. 6 is a partial cross-sectional view of the improved clothes hanging device shown in FIG. 4 wherein the substantially hollow cylindrically shaped tube contains a filler material;

FIG. 7 is an elevated perspective view of one embodiment of the improved clothes hanging device of the present invention wherein a pair of flanges are coupled together by a web that defines a channel therebetween and forms a one-piece substantially triangular shape having an apex coupled to a substantially hook-like shape;

FIG. 8 is a partial perspective view of a corner of the improved clothes hanging device shown in FIG. 8;

FIG. 9 is an elevated perspective view of one embodiment of the improved clothes hanging device of the present invention, showing a substantially hollow cylindrically shaped tube that forms a one-piece substantially triangular shaped having an apex coupled to a substantially hook-like shape;

FIG. 10 is a partial cross-sectional view of the improved clothes hanging device shown in FIG. 9;

FIG. 11 is a partial cross-sectional view of the improved clothes hanging device shown in FIG. 9, wherein the substantially hollow cylindrically shaped tube contains a filler material;

FIG. 12 is an elevated perspective view of one embodiment of the improved clothes hanging device of the present invention wherein a pair of flanges are coupled together by a web that defines a channel therebetween and forms a one-piece substantially inverted V-shape having an apex coupled to a substantially hook-like shape;

FIG. 13 is an elevated perspective view of one embodiment of the improved clothes hanging device of the present invention, showing a substantially hollow cylindrically shaped tube that forms a one-piece substantially inverted V-shape having an apex coupled to a substantially hook-like shape.

Common reference numerals are used throughout the drawings and detailed descriptions to indicate like elements.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

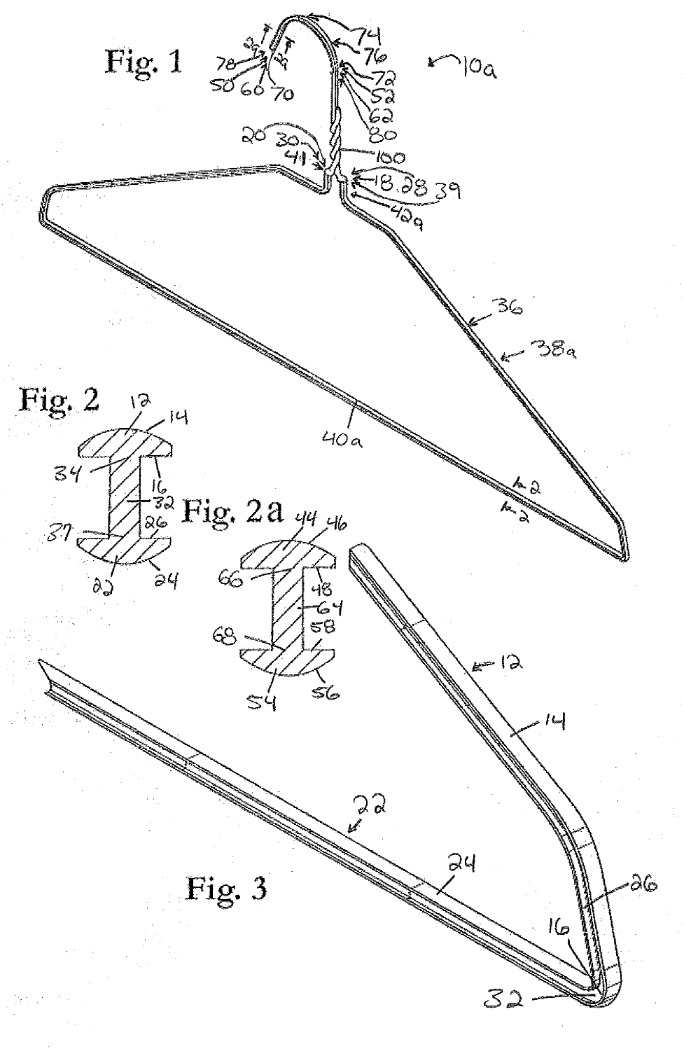

Referring to FIGS. 1-13, various embodiments of an improved clothes hanging device, referred to generically as an improved clothes hanging device 10, are disclosed.

Referring now to FIGS. 1, 2, 3, 7, 8, and 12, a preferred embodiment of an improved clothes hanging device 10, referred to specifically as an improved clothes hanging device 10a (shown in FIGS. 1, 7, and 12), is disclosed. The improved clothes hanging device 10a comprises a first flange 12 (shown in FIGS. 2, 3, and 8) having an outer surface 14 (shown in FIGS. 2, 3, and 8), an inner surface 16 (shown in FIGS. 2, 3, and 8), a first end 18 (shown in FIGS. 1, 7 and 12), and a second end 20 (shown in FIGS. 1, 7 and 12). The improved clothes hanging device 10a (shown in FIGS. 1, 7, and 12) also comprises a second flange 22 (shown in FIGS. 2, 3, and 8) having an outer surface 24 (shown in FIGS. 2, 3, and 8), an inner surface 26 (shown in FIGS. 2, 3, and 8), a first end 28 (shown in FIGS. 1, 7 and 12), and a second end 30 (shown in FIGS. 1, 7 and 12). The improved clothes hanging device 10a (shown in FIGS. 1, 7, and 12) also comprises a first web 32 (shown in FIGS. 2, 3, and 8) having a first end 39 (shown in FIGS. 1, 7 and 12) and a second end 41 (shown in FIGS. 1, 7 and 12) and a top surface 34 (shown in FIG. 2) coupled to the inner surface 16 (shown in FIGS. 2, 3, and 8) of the first flange 12 (shown in FIGS. 2, 3, and 8), and a bottom surface 37 (shown in FIG. 2) coupled to the inner surface 26 (shown in FIGS. 2, 3, and 8) of the second flange 22 (shown in FIGS. 2, 3, and 8). Together, the first flange 12, the second flange 22, and the first web 32 form a first portion 36 (shown in FIGS. 1, 7 and 12) of the improved clothes hanging device 10a.

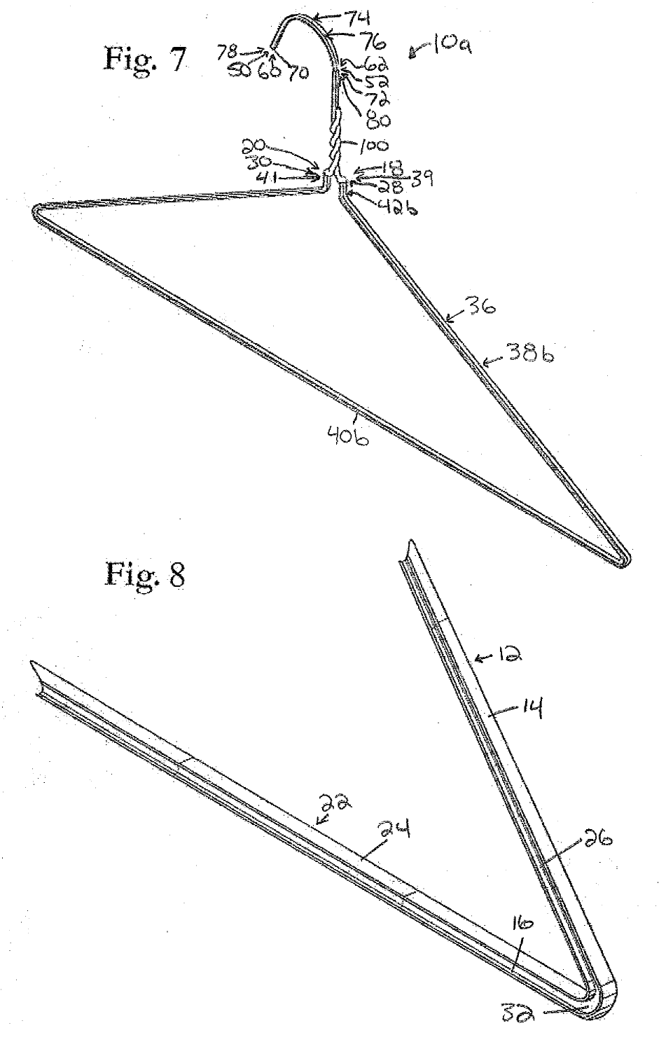

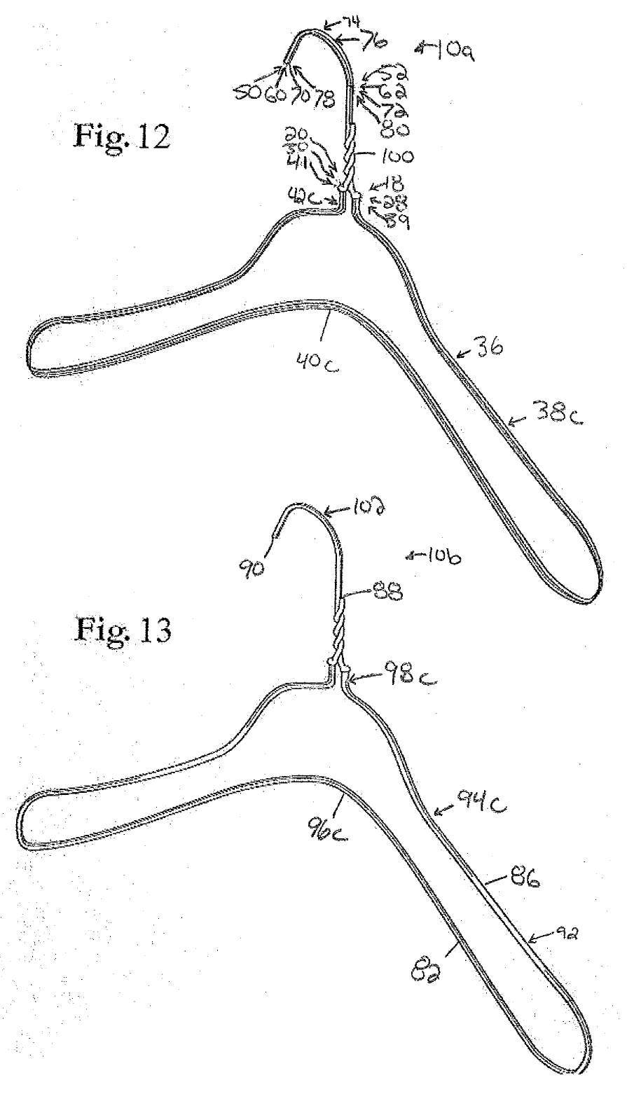

Referring to FIGS. 1, 7, and 12, in the preferred embodiment, the first portion 36 is formed into a substantially trapezoidal shape 38a (shown in FIG. 1) having a wide base 40a (shown in FIG. 1) and an apex 42a (shown in FIG. 1), though it should be clearly understood that substantial benefit could be derived from an alternative embodiment of the present invention in which the first portion 36 is a substantially triangular shaped 38b (shown in FIG. 7) having a wide base 40b (shown in FIG. 7) and an apex 42b (shown in FIG. 7) or a substantially inverted V-shape 38c (shown in FIG. 12) having a wide base 40c (shown in FIG. 12) and an apex 42c (shown in FIG. 12).

Referring to FIG. 2a, the improved clothes hanging device 10a also comprises a third flange 44 having an outer surface 46, an inner surface 48, a first end 50 (shown in FIG. 1), and a second end 52 (shown in FIG. 1) The improved clothes hanging device further comprises a fourth flange 54 having an outer surface 56, an inner surface 58, a first end 60 (shown in FIG. 1), and a second end 62 (shown in FIG. 1). The improved clothes hanging device 10a also comprises a second web 64 having a top surface 66 coupled to the inner surface 48 of the third flange 44, a bottom surface 68 coupled to the inner surface 58 of the fourth flange 54, and a first end 70 (shown in FIG. 1), and a second end 72 (shown in FIG. 1). Together, the third flange 44, the fourth flange 54 and the second web 64 for a second portion 74 (shown in FIGS. 1, 7 and 12) of the improved clothes hanging device 10a.

Referring to FIGS. 1, 7, and 12, the second portion 74 forms a substantially hook-like shape 76 having a distal end 78 and a proximate end 80. The proximate end 80 is coupled proximate to the apex 42a (shown in FIG. 1) of the first portion 36. In the preferred embodiment, the first portion 36 and the second portion 74 form a one-piece assembly that is a substantially I-shaped beam with the proximate end 80 of the second portion twisted to the apex 42.

Referring now to FIGS. 1-3, 7, 8, and 12, in the preferred embodiment, the proximate end 80 (shown in FIGS. 1, 7, and 12) of the substantially hook-like shape 76 (shown in FIGS. 1, 7, and 12) is coupled to apexes 42a (shown in FIG. 1), 42b (shown in FIG. 7), and 42c (shown in FIG. 12) with a coupling mechanism 100 (shown in FIGS. 1, 7, and 12), which is preferably a twisting of the existing material which is made of metal, aluminum, steel, an alloy, or a composite material, though it should be clearly understood that substantial benefit could be derived from an alternative embodiment of the present invention in which the coupling mechanism 100 consists of spot-welding, heating or in some other way strengthening or bonding the proximate end 80 of the substantially hook-like shape 76 (shown in FIGS. 1, 7, and 12) to apex 42a, 42b, or 42c. In the preferred embodiment, the aforementioned wide bases 40a (shown in FIG. 1), 40b (shown in FIG. 7), and 40c (shown in FIG. 12) are between approximately 15 inches and 18 inches, and the apex 42a of the substantially trapezoidal shape 38a (shown in FIG. 1) is between approximately 5 inches and 8 inches, though it should be clearly understood that substantial benefit could be derived from an alternative embodiment of the present invention in which the dimensions of the wide bases 40a, 40b, and 40c and the apex 42a of the substantially trapezoidal shape 38a deviate, even substantially, from the preferred dimensions, in either direction. In the preferred embodiment, the outer surfaces 14 (shown in FIG. 2), 24 (shown in FIG. 2), 46 (shown in FIG. 2a), 56 (shown in FIG. 2a) of the various flanges 12 (shown in FIG. 2), 22 (shown in FIG. 2), 44 (shown in FIG. 2a), 54 (shown in FIG. 2a) are substantially rounded, though it should be clearly understood that substantial benefit could be derived from an alternative embodiment of the present invention in which the outer surfaces 14, 24, 46, 56 of the various flanges 12, 22, 44, 54 are substantially flat or of an entirely different shape altogether. In the preferred embodiment, the various flanges 12, 22, 44, 54 and webs 32, 64 (shown in FIG. 2a) are composed of aluminum, steel, or a composite material, though it should be clearly understood that substantial benefit could be derived from an alternative embodiment of the present invention in which the various flanges 12, 22, 44, 54 and webs 32, 64 are composed of a different material.

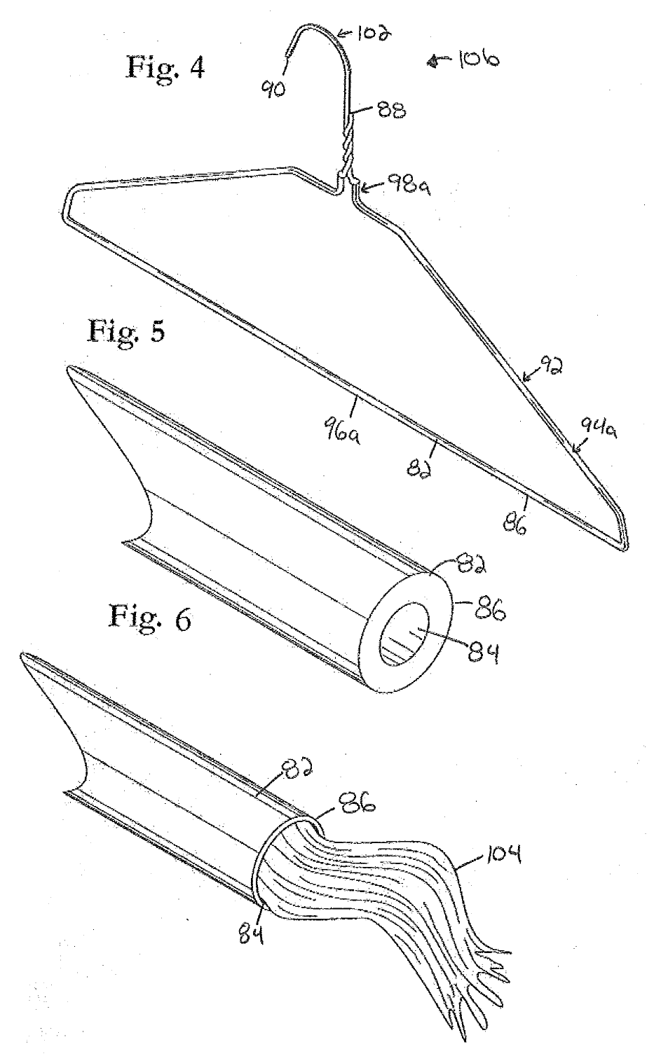

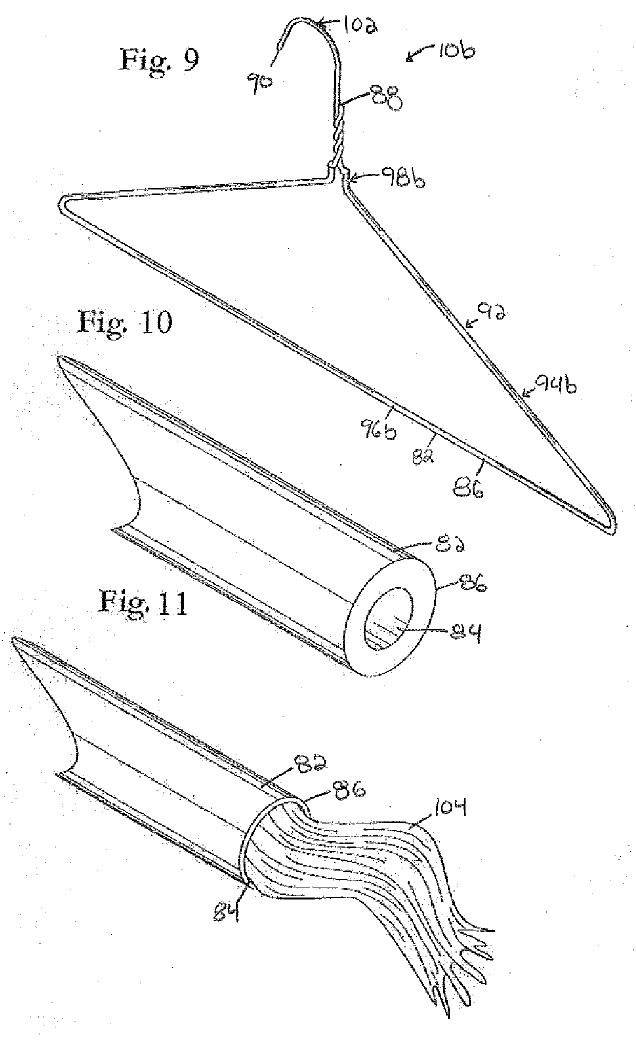

Referring now to FIGS. 4-6, 9-11, and 13, a second embodiment of the improved clothes hanging device 10, hereinafter referred to specifically as an improved clothes hanging device 10b (shown in FIGS. 4, 9, and 13), is disclosed. The improved clothes hanging device 10b (shown in FIGS. 4, 9, and 13) comprises a substantially hollow cylindrically shaped tube 82 having an inner surface 84 (shown in FIGS. 5, 6, 10, and 11), an outer surface 86, a first end 88 (shown in FIGS. 4, 9, and 13), and a second end 90 (shown in FIGS. 4, 9, and 13). In the preferred embodiment, the substantially hollow cylindrically shaped tube 82 forms a first portion 92 (shown in FIGS. 4, 9, and 13) and a second portion 102 (shown in FIGS. 4, 9, and 13). The first portion 92 is formed into a substantially trapezoidal shape 94a (shown in FIG. 4) having a wide base 96a (shown in FIG. 4) and an apex 98a (shown in FIG. 4), though it should be clearly understood that substantial benefit could be derived from an alternative embodiment of the present invention in which the first portion 92 is a substantially triangular shape 94b (shown in FIG. 9) having a wide base 96b (shown in FIG. 9) and an apex 98b (shown in FIG. 9) or a substantially inverted V-shape 94c (shown in FIG. 13) having a wide base 96c (shown in FIG. 13) and an apex 98c (shown in FIG. 13). The second portion 94 forms a substantially hook-like shape 102 (shown in FIGS. 4, 9, and 13) proximate the aforementioned apexes 98 (shown in FIGS. 4, 9, and 13). In the preferred embodiment, the substantially hollow cylindrically shaped tube 82 is comprised of aluminum, steel tube, fiber glass, carbon fiber, reinforced fiber glass resin, or plastic, though it should be clearly understood that substantial benefit could be derived from an alternative embodiment of the present invention in which the substantially hollow cylindrically shaped tube 82 is comprised of some other material. In the preferred embodiment, the wide bases 96 are between approximately 15 inches and 18 inches, and the apex 98a of the substantially trapezoidal shape 94a is between approximately 5 inches and 8 inches, though it should be clearly understood that substantial benefit could be derived from an alternative embodiment of the present invention in which the dimensions of the wide bases 96a, 96b, and 96c and the apex 98a deviate, even substantially, from the preferred dimensions, in either direction. In the preferred embodiment, a filler material 104 (shown in FIGS. 6 and 11) is disposed proximate the inner surface 84 of the substantially hollow cylindrically shaped tube 82. The filler material 104 (shown in FIGS. 6 and 11) is preferably made of string, rope, yarn, composite material, or stabilizing filler material, though it should be clearly understood that substantial benefit could be derived from an alternative embodiment of the present invention in which the filler material 104 is comprised of some other material, or in which no filler material 104 is used at all.

I claim:

1. An improved clothes hanging device comprising:
a first flange having an outer surface and an inner surface and a first end and a second end;
a second flange having an outer surface and an inner surface and a first end and a second end;
a first web having a top surface and a bottom surface and a first end and a second end, said inner surface of said first flange coupled to said top surface of said first web, said inner surface of said second flange coupled to said bottom surface of said first web so that said first flange and said second flange and said first web forming a first portion defining a channel between said first flange and said second flange, said first portion being formed into one of a substantially triangular shape and a substantially trapezoidal shape and a substantially inverted V-shape having a wide base and an apex;
a third flange including an outer surface and an inner surface and a first end and a second end;
a fourth flange including an outer surface and an inner surface and a first end and a second end; and
a second web having a top surface and a bottom surface and a first end and a second end, said inner surface of third first flange coupled to said top surface of said second web, said inner surface of said fourth flange coupled to said bottom surface of said second web so that said third flange and said fourth flange and said second web forming a second portion defining a channel between said third flange and said fourth flange, said second portion being formed into a substantially hook-like shape having a distal end and a proximate end, said proximate end of said substantially hook-like shaped second portion coupled proximate said apex of one of said substantially triangularly shaped first portion and said substantially trapezoidally shaped first portion and said substantially inverted V-shaped first portion, said first portion and said second portion forming a one-piece assembly.

2. The improved clothes hanging device of claim 1 further comprising a coupling mechanism having a first end coupled to said proximate end of said substantially hook-like shaped device and a second end coupled to said apex of one of said substantially triangularly shaped device and said substantially trapezoidally shaped device and said substantially inverted V-shaped device.

3. The improved clothes hanging device of claim 2 wherein said coupling mechanism being a twisted material.

4. The improved clothes hanging device of claim 3 wherein said twisted material being one of a metal and aluminum and steel and an alloy and a composite material.

5. The improved clothes hanging device of claim 1 wherein one of said substantially triangularly shaped device and said substantially inverted V-shaped device having said wide base of between approximately 15 inches and 18 inches.

6. The improved clothes hanging device of claim 1 wherein said substantially trapezoidally shaped device having said wide base of between approximately 15 inches and 18 inches and an apex of between approximately 5 inches and 8 inches.

7. The improved clothes hanging device of claim 1 wherein said outer surface of said first flange and said outer surface of said second flange and said outer surface of said third flange and said outer surface of said fourth flange being substantially rounded.

8. The improved clothes hanging device of claim 1 wherein said first web and said second web and said first flange and said second flange and said third flange and said fourth flange being composed of one of aluminum and steel and a composite material.

9. An improved clothes hanging device comprising a substantially hollow cylindrically shaped tube having an inner surface and an outer surface and a first end and a second end, said substantially hollow cylindrically shaped tube forming a first portion and a second portion, said first portion being formed into one of a substantially triangular shape having an apex and a wide base and a substantially inverted V-shape having an apex and a wide base and a substantially trapezoidal shape having a wide base and an apex, said second portion forming a substantially hook-like shape proximate one of said apex of said substantially triangularly shaped first portion and said apex of said substantially trapezoidally shaped first portion and said apex of said substantially inverted V-shaped first portion.

10. The improved clothes hanging device of claim 9 wherein said substantially hollow cylindrically shaped tube being comprised of one of aluminum and steel tube and fiber glass and carbon fiber and reinforced fiber glass resin and plastic.

11. The improved clothes hanging device of claim 9 wherein one of said substantially triangularly shaped device and said substantially inverted V-shaped device having said wide base of between substantially 15 inches and 18 inches.

12. The improved clothes hanging device of claim 9 wherein said substantially trapezoidally shaped device having said wide base of between approximately 15 inches and 18 inches and an apex of between approximately 5 inches and 8 inches

13. The improved clothes hanging device of claim 9 further comprising a filler material disposed proximate said inner surface of said substantially hollow cylindrically shaped tube.

14. The improved clothes hanging device of claim 13 wherein said filler material being made of one of string and rope and yarn and composite material and stabilizing filler material.

15. A method of forming an improved clothes hanging device comprising the steps of:
providing a piece of material;
rolling said material into a substantially I-shaped beam;
bending a first portion of said I-shaped beam into one of a substantially triangular shape and a substantially trapezoidal shape and a substantially inverted V-shape having a wide base and an apex;
bending a second portion of said substantially I-shaped beam into a substantially hook-like shape having a distal end and a proximate end; and
strengthening a third portion of said substantially I-shaped beam, said third portion of said substantially I-shaped beam being disposed between said proximate end of said substantially hook-like shaped second portion and said apex of said first portion, said strengthening being one of twisting and welding and heating.

16. The method of claim 16 further comprising, in combination, the steps of:
hanging an article of clothing by placing said article of clothing about one of said substantially triangularly shaped first portion and said substantially trapezoidally shaped first portion and said substantially inverted V-shaped first portion; and
placing said substantially hook-like shaped second portion about one of a fixture and a horizontal member.
